(19) United States
(12) Patent Application Publication
(10) Pub. No.: US 2021/0356033 A1
(43) Pub. Date: Nov. 18, 2021

(54) DIFFERENTIAL DEVICE

(71) Applicant: MUSASHI SEIMITSU INDUSTRY CO., LTD., TOYOHASHI-SHI, AICHI (JP)

(72) Inventors: Hirohisa ODA, TOYOHASHI-SHI, AICHI (JP); Hiroyuki MORI, TOYOHASHI-SHI, AICHI (JP)

(21) Appl. No.: 17/282,140

(22) PCT Filed: Oct. 23, 2019
(86) PCT No.: PCT/JP2019/041495

§ 371 Date: Apr. 1, 2021

(30) Foreign Application Priority Data
Oct. 31, 2018 (JP) 2018-205839

(51) Int. Cl. F16H 57/04; F16H 48/08

(52) U.S. Cl. CPC F16H 57/043; F16H 48/08; F16H 2048/085; F16H 2048/087; F16H 57/0483

(57) ABSTRACT

In a differential device including a pair of side gears, a plurality of pinion gears and a pinion shaft, the pinion shaft includes a plurality of shaft parts rotatably fitted to and supporting the plurality of pinion gears respectively, and an annular support part linking the plurality of shaft parts to each other, an annular recess portion is formed in an inner peripheral face of the support part, the pinion shaft has an oil guide part that guides lubricating oil within the recess portion to a part where the shaft part and the pinion gear are fitted together, and an inner end portion of at least one of the side gears protrudes into an inner space of the support part and is positioned within a width of the recess portion in an axial direction of the rotating shaft.

### TECHNICAL FIELD

The present invention relates to a differential device, and in particular to a differential device that includes a pair of side gears linked to a pair of rotating shafts respectively, a plurality of pinion gears meshing with the pair of side gears, and a pinion shaft rotatably supporting the plurality of pinion gears.

### BACKGROUND ART

The arrangement of a conventional differential device in which a pinion shaft is formed from a plurality of shaft parts rotatably fitted to and supporting a plurality of pinion gears, and an annular support part linking the shaft parts to each other, an annular recess part that can receive lubricating oil is formed in an inner peripheral face of the support part, and the lubricating oil collected in the recess part can be supplied from the recess part to a part (that is, a rotating sliding part) where the pinion shaft and the shaft part are fitted together is already known from for example Patent Document 1.

### RELATED ART DOCUMENTS

### Patent Documents

Patent Document 1: Japanese Patent Application Laid-open No. 2015-224654

### SUMMARY OF THE INVENTION

### Problems to be Solved by the Invention

In a conventional differential device, it is usual to supply lubricating oil to a central part of the interior of a differential case via a part where a side gear is fitted and linked to a rotating shaft.

However, in the differential device of Patent Document 1 above, in relation to an inner end part in the axial direction of the side gear being positioned further outward in the axial direction than the support part of the pinion shaft, lubricating oil flowing out via the inner end part cannot be efficiently collected in the recess part in the inner periphery of the support part, and there is therefore the problem that it is impossible to supply sufficient lubricating oil to a rotating sliding part of the pinion gear via the recess part.

The present invention has been proposed in light of the above circumstances, and it is an object thereof to provide a differential device that can solve the above problem with a simple structure.

### Means for Solving the Problems

In order to attain the above object, according to a first aspect of the present invention, there is provided a differential device comprising a pair of side gears linked to a pair of rotating shafts respectively, a plurality of pinion gears meshing with the pair of side gears, and a pinion shaft supporting the plurality of pinion gears, characterized in that the pinion shaft comprises a plurality of shaft parts rotatably fitted to and supporting the plurality of pinion gears respectively, and an annular support part linking the plurality of shaft parts to each other, an annular recess portion is formed in an inner peripheral face of the support part, the pinion shaft has an oil guide part that guides lubricating oil within the recess portion to a part where the shaft part and the pinion gear are fitted together, and an inner end portion of at least one of the side gears protrudes into an inner space of the support part and is positioned within a width of the recess portion in an axial direction of the rotating shaft.

Further, according to a second aspect of the present invention, in addition to the first aspect, a protruding portion is provided on the inner peripheral face of the support part between the recess portion and an outer end face of the support part in the axial direction, the protruding portion extending in a peripheral direction of the support part and protruding inward in a radial direction.

Furthermore, according to a third aspect of the present invention, in addition to the second aspect, a side face, on a side facing the recess portion, of the protruding portion is formed so as to be inclined toward a bottom face side of the recess portion in going inward in the axial direction from an extremity of the protruding portion.

Moreover, according to a fourth aspect of the present invention, in addition to any one of the first to third aspects, the pair of side gears each comprise a side gear main body having a tooth portion, and a boss portion integrally joined to an inner peripheral part of the side gear main body and fitted and linked to the corresponding rotating shaft, the inner end portion of the boss portion being present further inward than the side gear main body in the axial direction and projecting into an inner space of the support part, and the inner end portions of the boss portions of the pair of side gears opposing each other with a gap sandwiched therebetween through which lubricating oil can flow.

Further, according to a fifth aspect of the present invention, in addition to any one of the first to fourth aspects, the pinion shaft has a through hole having one end opening on an inner face of the recess portion and having the other end opening on an outer peripheral portion of the shaft part or a portion, adjacent to the shaft part, of the support part, and the through hole forms the oil guide part.

Furthermore, according to a sixth aspect of the present invention, in addition to any one of the first to fifth aspects, part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

### Effects of the Invention

In accordance with the first aspect, since the annular recess part extending in the peripheral direction is formed in the inner peripheral face of the annular support part linking the plurality of shaft parts of the pinion shaft to each other, the pinion shaft has the oil guide part guiding lubricating oil within the recess part to the part where the shaft part is fitted to the pinion gear, and the inner end part of at least one side gear protrudes into the inner space of the support part and is positioned within the width of the recess part in the axial direction of the rotating shaft, it is possible to efficiently collect in the recess part of the support part of the pinion shaft lubricating oil flowing out via the inner end part of the side gear, and it is possible to sufficiently supply it from the recess part to the part where the pinion gear and the shaft part are fitted together. It is thereby possible to carry out sufficient lubrication for the rotating sliding part between the shaft part and the pinion gears, thus enabling an effect in preventing seizure of the rotating sliding part or suppressing abrasion to be exhibited.

Furthermore, in accordance with the second aspect, since the protruding portion is provided on the inner peripheral face of the support part between the recess portion and the outer end face of the support part in the axial direction, the protruding portion extending in the peripheral direction of the support part and protruding inward in the radial direction, it is possible to narrow to some extent by means of the protruding portion the flow of lubricating oil, which flows out from the inner end portion of the side gear and heads toward the tooth part side of the side gear along the outer periphery of the inner end portion, and it is possible to accordingly increase the amount of lubricating oil supplied to the recess portion, thus enhancing the effect in lubricating the rotating sliding part.

Moreover, in accordance with the third aspect, since the side face, on the side facing the recess portion, of the protruding portion is formed so as to be inclined toward the bottom face side of the recess portion in going inward in the axial direction from the extremity of the protruding portion, it is possible to efficiently collect in the recess portion lubricating oil that has flowed out via the inner end portion of the side gear so as to be scattered by virtue of centrifugal force because of the inclined side face of the protruding portion functioning as a guide face, and it is possible to accordingly increase the amount of lubricating oil supplied to the recess portion, thus further enhancing the effect in lubricating the rotating sliding part.

Furthermore, in accordance with the fourth aspect, since the side gear includes the side gear main body having the tooth portion, and the boss portion integrally joined to the inner peripheral part of the side gear main body and fitted and linked to the corresponding rotating shaft, and the inner end portion of the boss portion is present further inward than the side gear main body in the axial direction and projects into the inner space of the support part, due to the boss portion of the side gear extending to the interior of the support part, it is possible to ensure a large length via which the boss portion is fitted onto the rotating shaft in the axial direction (that is, the length via which they are linked) compared with the axial dimension of the side gear main body, and even if the side gear main body (and consequently the differential device) is relatively flat in the axial direction, the strength via which the side gear and the rotating shaft are linked can easily be ensured. Even when the boss portion is extended to the interior of the support part as described above, since the inner end portions of the boss portions of the two side gears oppose each other while sandwiching therebetween the gap through which lubricating oil can flow, although the inner end portions of the boss portions of the two side gears are disposed close to each other, it is possible to supply without problem lubricating oil to the recess part via the inner end portions of the boss portions through the gap therebetween.

Moreover, in accordance with the fifth aspect, since the pinion shaft has the through hole having one end opening on the inner face of the recess portion and having the other end opening on the outer peripheral portion of the shaft part or a portion, adjacent to the shaft part, of the support part, it is possible to reliably supply lubricating oil within the recess part through the through hole to the part, that is, the rotating sliding part, where the pinion gear is fitted to the shaft part.

Furthermore, in accordance with the sixth aspect, since part of the surface of each of the shaft part and the support part is cut out, and the cutout portion forms the lubricating oil passage extending from the interior of the recess portion to the part where the shaft part and the pinion gear are fitted together, it is possible to reliably supply lubricating oil within the recess part through the cutout portion to the part, that is, the rotating sliding part, where the pinion gear is fitted to the shaft part. Moreover, the cutout portion can be formed relatively easily.

### BRIEF DESCRIPTION OF DRAWINGS

FIG. 1 is an overall sectional view (a sectional view along line 1-1 in FIG. 2) showing a differential device related to a first embodiment of the present invention.

FIG. 2 is a sectional view along line 2-2 in FIG. 1.

FIG. 3 is an enlarged view of a part shown by arrow 3 in FIG. 1.

FIG. 4 is a perspective view showing a pinion shaft on its own.

FIG. 5 (A) is a sectional view, corresponding to FIG. 3, of a second embodiment, and FIG. 5 (B) is a sectional view, corresponding to FIG. 3, of a third embodiment.

### EXPLANATION OF REFERENCE NUMERALS AND SYMBOLS

C Differential case
D Differential device
S1, S2 Left and right drive shafts as pair of rotating shafts
20 Side gear
20b Boss portion
20m Side gear main body
20mg Tooth portion
30 Pinion shaft
31 Shaft part
31c Cutout portion of shaft part
32 Support part
32c Cutout portion of support part
32d Recess portion
30h Through hole forming oil guide part
32p Protruding portion
32ps Side face
35 Lubricating oil passage forming oil guide part
40 Pinion gear

### MODES FOR CARRYING OUT THE INVENTION

Embodiments of the present invention are explained below by reference to the attached drawings.

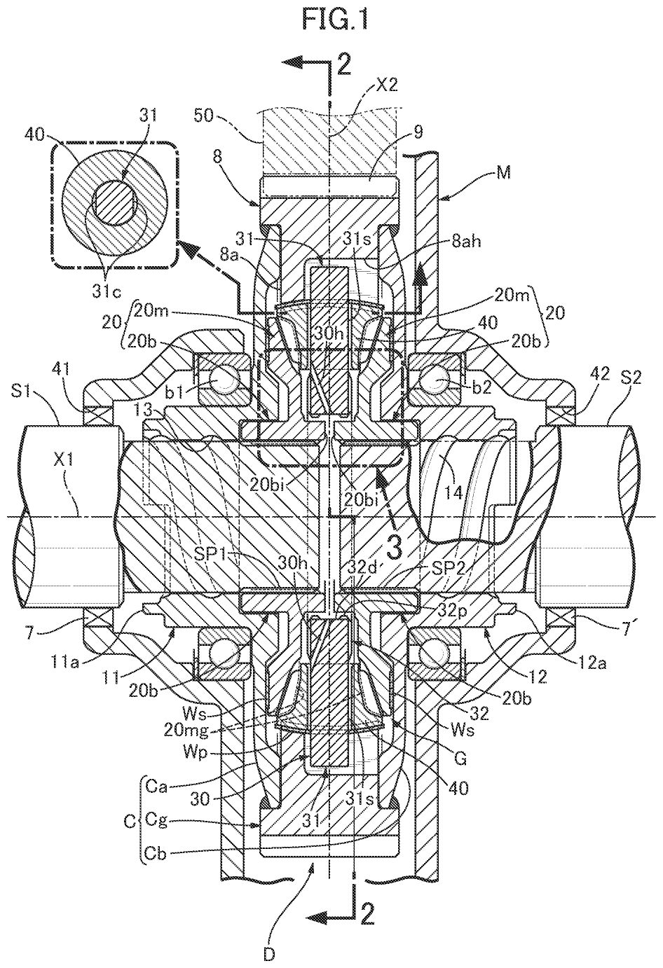

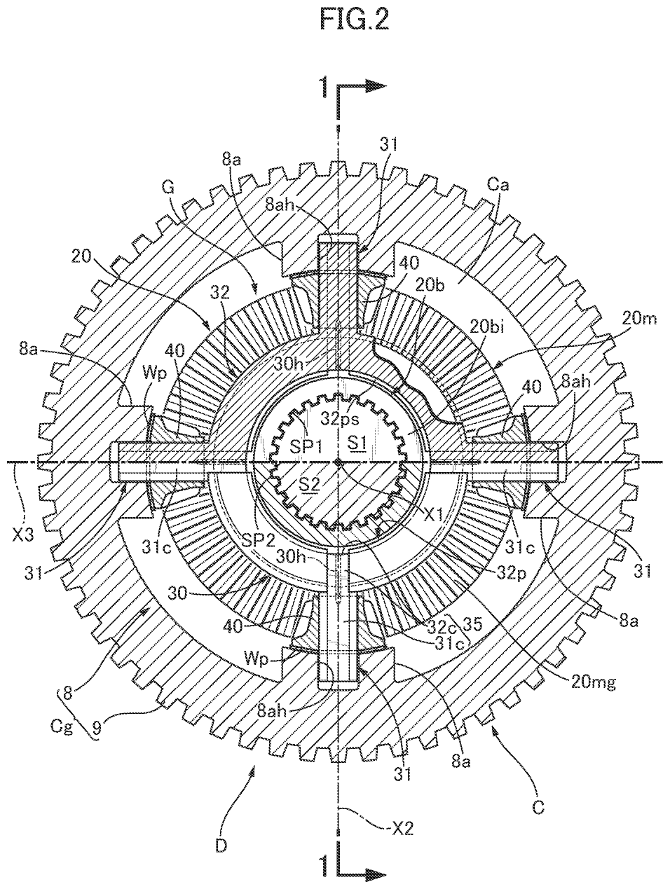

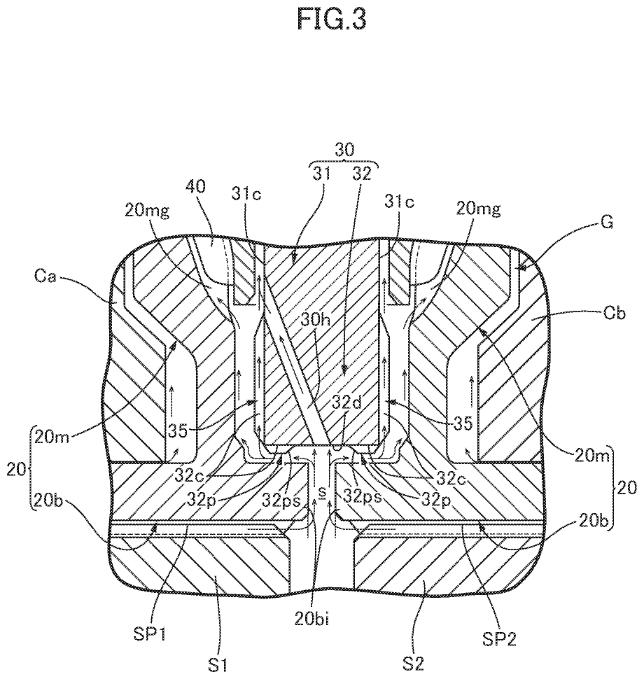

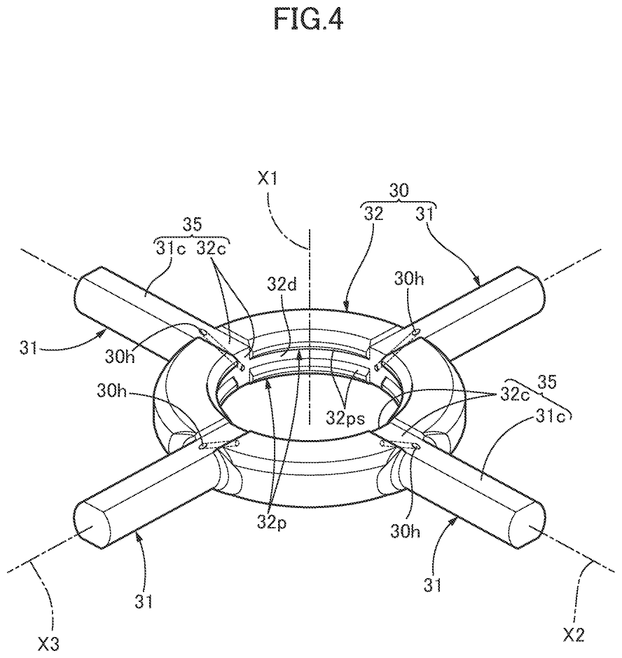

First, a first embodiment of the present invention shown in FIG. 1 to FIG. 4 is explained. In FIG. 1, a differential device D as a transmission device is housed within a transmission case M of an automobile together with a gear shift device, which is not illustrated.

This differential device D has a ring gear Cg as an input part that rotates in association with an output side (for example, an output gear 50) of the gear shift device, and distributes the rotational driving force of the ring gear Cg between left and right drive shafts S1, S2 (that is, a pair of rotating shafts) relatively rotatably arranged on a central axis of the differential device D, that is, a first axis X1, while allowing differential rotation. A seal is provided between the left and right drive shafts S1, S2 and the transmission case M by means of seal members 7, 7′ respectively, and left and right driven wheels, which are not illustrated, rotate in association with the left and right drive shafts S1, S2 respectively.

A bottom part of the transmission case M is formed as an oil pan (not illustrated) that can store a predetermined amount of lubricating oil. The lubricating oil stored in the oil pan is stirred vigorously by rotation of a movable part within the transmission case M, for example a differential case C, which is described later, and scattered over a wide range in a space within the case M, and a part to be lubricated within the transmission case M can be lubricated with the lubricating oil thus scattered. In addition to (or instead of) the above lubrication structure, lubricating oil fed under pressure by pumping means such as an oil pump may be forcibly supplied under pressure to each part of the transmission case M.

The differential device D includes the differential case C, which is supported on the transmission case M so that it can rotate around the first axis X1, and a differential gear mechanism G, which is described later, housed within the differential case C. In the present Description, the direction along the first axis X1 is simply called the axial direction, and the radial direction and the circumferential direction of the differential case C are simply called the radial direction and the peripheral direction, respectively.

The differential case C includes the ring gear Cg as a helical gear, and disk-shaped left and right side wall parts Ca, Cb having outer peripheral end parts fitted and fixed (for example welded) to an annular step part formed on each of opposite outside faces in the axial direction of the ring gear Cg respectively. Provided in the vicinity of the outer peripheral end of at least one of the left and right side wall parts Ca, Cb is a drain hole (not illustrated) that is capable of appropriately discharging excess lubricating oil within the differential case C by virtue of centrifugal force, etc. As means for fixing the ring gear Cg and each of the side wall parts Ca, Cb, as well as welding, various fixing means (for example, bolting, swaging, riveting) may be employed as appropriate.

The ring gear Cg has a short cylindrical ring gear main body 8 and a tooth part 9 formed from a helical gear provided on the outer periphery of the ring gear main body 8. Projectingly provided integrally with an inner peripheral part of the ring gear main body 8 at equal intervals in the peripheral direction are four supporting projection portions 8a protruding inward in the radial direction, and recessed in each supporting projection portion 8a is a support groove 8ah extending in the axial direction so as to open on one end side in the axial direction. Each support groove Bah is used for linking and supporting a pinion shaft 30, which is described later, and an extremity face (that is, an inner end face in the radial direction) of the supporting projection portion 8a is formed into a spherical or tapered shape and forms a pinion support face that rotatably and slidably supports a back face of a pinion gear 40, which is described later, via a pinion washer Wp.

The ring gear Cg may be formed from a gear other than a helical gear, for example a spur gear, or may be formed from a transmission wheel other than a gear, for example a V pulley or a sprocket.

The left and right side wall parts Ca, Cb integrally have left and right cylindrical bearing bosses 11, 12 respectively, protruding outward in the axial direction from a respective inner peripheral end part and arranged on the first axis X1. Outer peripheral parts of the bearing bosses 11, 12 are rotatably supported on the transmission case M via bearings b1, b2. The left and right drive shafts S1, S2 are fitted into and supported on the inner peripheral parts of the left and right bearing bosses 11, 12 so that they can rotate around the first axis X1. Helical grooves 13, 14 are formed in at least one of mating faces thereof (the inner peripheral faces of the bearing bosses 11, 12 in the illustrated example).

The helical grooves 13, 14 exhibit a screw pump action by the bearing bosses 11, 12 and the respective drive shafts S1, S2 undergoing relative rotation at least when the automobile is driven forward (that is, when the drive shafts S1, S2 rotate forward), and thereby actively draw in scattered lubricating oil within the transmission case M into the differential case C.

The outer end of each helical groove 13, 14 opens in the interior of the transmission case M, and the inner end thereof opens in the interior of the differential case C. Projectingly provided on outer end faces of the bearing bosses 11, 12 are guide portions 11a, 12a that can efficiently guide the entry of lubricating oil into the respective helical grooves 13, 14 from the interior of the transmission case M.

The helical grooves 13, 14 are specially provided as lubricating oil supply means that can supply lubricating oil within the transmission case M to the interior of the differential case C (for example, spline fitting parts SP1, SP2 between the drive shafts S1, S2 and a side gear 20, which is described later). Lubricating oil that is fed under pressure by pumping means such as, for example, an oil pump as another lubricating oil supply means in addition to or instead of the helical grooves 13, 14 may be supplied to the interior of the differential case C via an oil passage (not illustrated) provided in the drive shafts S1, S2 and/or the differential case C.

The structure of the differential gear mechanism G within the differential case C is now explained. The differential gear mechanism G includes left and right side gears 20 relatively non-rotatably linked to the left and right drive shafts S1, S2 respectively, four of the pinion gears 40 sandwiched between the left and right side gears 20 and meshing with the two side gears 20, and the pinion shaft 30 supporting each of the pinion gears 40. The side gears 20 and the pinion gears 40 are all formed from bevel gears.

The left and right side gears 20 each include a side gear main body 20m having a tooth portion 20mg on its outer peripheral part and formed into a disk shape having a relatively small thickness in the axial direction, and a boss portion 20b integrally joined to an inner peripheral part of the side gear main body 20m. The boss portion 20b is formed into a cylindrical shape having a larger width in the axial direction than that of the side gear main body 20m, and extends so as to protrude further inward and outward in the axial direction than the side gear main body 20m does. A back face of each side gear main body 20m is rotatably and slidably supported on an inner face of the corresponding side wall part Ca, Cb of the differential case C via a side gear washer Ws.

An inner peripheral face of the boss portion 20b is axially slidably fitted onto an outer peripheral face of an inner end part of the corresponding left and right drive shafts S1, S2 by spline fittings SP1, SP2. An outer peripheral face of the boss portion 20b is rotatably fitted to and supported on the bearing bosses 11, 12 of the corresponding side wall parts Ca, Cb of the differential case C.

In particular, an inner end portion 20bi of the boss portion 20b is present further inward in the axial direction than the side gear main body 20m (further on the center side of the differential case C) and protrudes into an inner space of the pinion shaft 30 (a support part 32, which is described later). Moreover, the inner end portions 20bi of the left and right boss portions 20b are closely opposed to each other with an annular gap s therebetween through which lubricating oil can flow.

The pinion shaft 30 includes four shaft parts 31 rotatably fitted into and supporting the four pinion gears 40 respectively, and an annular support part 32 integrally joining inner ends of the shaft parts 31 to each other. That is, the four shaft parts 31 extend radially from the outer periphery of the annular support part 32, and are disposed so as to extend on second and third axes X2, X3 orthogonal to each other within one plane orthogonal to the first axis X1.

Each shaft part 31 is engaged with the support groove Bah in the inner periphery of the ring gear main body 8 so that it can slide in the axial direction and cannot undergo relative rotation around the first axis X1. In accordance with this engagement, the pinion shaft 30 is linked to the ring gear Cg (and consequently the differential case C) so as to integrally rotate around the first axis X1 while allowing sliding in the axial direction.

Formed in an inner peripheral face of the support part 32 is a recess portion 32d having an annular groove shape extending in the peripheral direction of the support part 32. The recess portion 32d of the first embodiment in particular is formed between a pair of left and right protruding portions 32p by providing the two protruding portions 32p integrally with the inner peripheral face of the support part 32 so as to face inward in the radial direction. The two protruding portions 32p extend in the peripheral direction with a gap in the axial direction therebetween, and side faces of the two protruding portions 32p, mutually opposing inside faces in particular (that is, side faces 32ps on the side facing the recess portion 32d) are formed so as to be inclined toward a bottom face side of the recess portion 32d in going inward in the axial direction from the extremity of the protruding portion 32p (that is, the radially inner end).

Moreover, an inner end part in the axial direction of each of the left and right side gears 20 (more specifically, the inner end portion 20bi of the boss portion 20b) not only protrudes into the inner space of the support part 32 but also is positioned within the width of the recess portion 32d in the axial direction.

Furthermore, the pinion shaft 30 has first and second oil guide parts guiding lubricating oil building up within the recess portion 32d to the part where the pinion gears 40 and the shaft part 31 are fitted together. That is, the pinion shaft 30 has a through hole 30h having one end opening on an inner face of the recess portion 32d and having the other end opening in an outer peripheral portion of the shaft part 31 or a portion that is adjacent to the shaft part 31 of the support part 32, and this through hole 30h forms the first oil guide part. The through hole 30h of the present embodiment is formed from a linear hole that is inclined radially outward in going from the bottom face of the recess portion 32d to the outside in the axial direction when viewed on a projection plane parallel to the axis of the shaft part 31 and the first axis X1 (that is, the same direction as in FIG. 1).

An outside face, in a direction along the first axis X1, of each shaft part 31 and an outside face and inner peripheral face (more specifically, the protruding portion 32p) of the support part 32 are cut out so that portions of these faces are linked together, and a lubricating oil passage 35 is formed from a series of cutout portions 31c, 32c so as to extend continuously from the interior of the recess portion 32d to the fitted part between the shaft part 31 and the pinion gear 40. The lubricating oil passage 35 forms the second oil guide part. The cutout portions 31c, 32c can easily be formed by machining the outer face of each of the shaft part 31 and the support part 32.

The operation of the embodiment is now explained.

The assembled differential device D is incorporated into the transmission case M, the left and right drive shafts S1, S2 are subsequently inserted into the transmission case M via through holes 41, 42 of the transmission case M, the inner end parts of the two drive shafts S1, S2 are fitted into the inner peripheral faces of the boss portions 20b of the pair of side gears 20 by the spline fittings SP1, SP2, and the spaces between the inner faces of the through holes 41, 42 and the drive shafts S1, S2 are sealed by means of the annular seal members 7, 7′. Lubricating oil is subsequently poured into the transmission case M.

While the automobile is traveling, the rotational driving force from a power source is transmitted to the differential case C via the ring gear Cg, and the rotational driving force thus transmitted is further transmitted to the pair of side gears 20 via the pinion shaft 30 and the pinion gear 40 and then to the pair of drive shafts S1, S2. The two drive shafts S1, S2 are thus rotated while the differential gear mechanism G allows differential rotation therebetween.

In such a transmission process, lubricating oil is scattered within the transmission case M accompanying rotation of the differential case M and another movable member, and part of the lubricating oil is actively drawn into the differential case C by for example the helical grooves 13, 14, which exhibit a screw pump action accompanying relative rotation between the bearing bosses 11, 12 and the respective drive shafts S1, S2.

The lubricating oil thus drawn in flows inward in the axial direction through for example the spline fitting parts SP1, SP2 between the drive shaft S1, S2 and the boss portion 20b of the side gear 20 and reaches the inner end portion 20bi of the boss portion 20b, and is scattered and moved therefrom outward in the radial direction by virtue of centrifugal force, thereby being efficiently collected on the inner periphery of the annular support part 32 of the pinion shaft 30, in particular within the annular recess portion 32d.

In this case, since the pinion shaft 30 has the through hole 30h having one end opening on the inner face of the recess portion 32d and having the other end opening in the outer peripheral portion of the shaft part 31 or a portion, adjacent to the shaft part 31, of the support part 32, it is possible to efficiently and reliably supply lubricating oil within the recess portion 32d through the through hole 30h to the parts where the pinion gears 40 and the shaft part 31 are fitted together, that is, rotating sliding parts. Part of the lubricating oil passing through the through hole 30h is also supplied to a tooth part (and consequently a part meshing with the side gear 20) of the pinion gear 40 or a rotating sliding part between the back face of the pinion gear 40 and the pinion washer Wp or the supporting projection portion 8a.

Moreover, since parts of the surfaces of the shaft part 31 and the support part 32 are cut out so as to be linked together, and the lubricating oil passage 35 extending from the interior of the recess portion 32d to the part where the shaft part 31 and the pinion gear 40 are fitted together is formed by the series of cutout portions 31c, 32c, it is possible to efficiently and reliably supply lubricating oil within the recess portion 32d through the lubricating oil passage 35 (that is, the cutout portions 31c, 32c) to the part where the pinion gears 40 and the shaft part 31 are fitted together, that is, the rotating sliding part. Part of the lubricating oil passing through the lubricating oil passage 35 is also supplied to the tooth part (and consequently the part meshing with the side gear 20) of the pinion gear 40 or the rotating sliding part between the back face of the pinion gear 40 and the pinion washer Wp or the supporting projection portion 8a.

Part of the lubricating oil drawn into the differential case C by virtue of the screw pump action of the helical grooves 13, 14 described above is also supplied to the rotating sliding part between the back face of the side gear 20 and the side gear washer Ws or the inner faces of the side wall parts Ca, Cb via a sliding gap between the bearing bosses 11, 12 and the boss portion 20b on the outer side in the axial direction of the side gear 20 without going through the spline fitting part SP1, SP2.

As explained above, with regard to the side gear 20 of the present embodiment, since the inner end part thereof (specifically, the inner end portion 20bi of the boss portion 20b) protrudes into the inner space of the annular support part 32 of the pinion shaft 30, and is positioned within the width in the axial direction of the annular recess portion 32d in the inner periphery of the support part 32, it is possible to efficiently collect lubricating oil, which has been scattered and made to flow out by virtue of centrifugal force from the inner end portion 20bi of the side gear 20, in the interior of the recess portion 32d extending lengthwise in the peripheral direction of the inner peripheral face of the annular support part 32. Since this enables lubricating oil that has been collected in the interior of the recess portion 32d to be sufficiently supplied, via the oil guide part of the pinion shaft 30 (the through hole 30h and the lubricating oil passage 35 described above), to the part, that is, the rotating sliding part, where the pinion gear 40 is fitted to the shaft part 31, the tooth part of the pinion gear 40 (and consequently the part meshing with the side gear 20), and the rotating sliding part between the back face of the pinion gear 40 and the pinion washer Wp or the supporting projection portion 8a, these rotating sliding parts and meshing parts can be sufficiently lubricated, and this is effective for preventing seizure or suppressing abrasion.

In particular, the inner peripheral face of the annular support part 32 of the pinion shaft 30 is provided with the pair of protruding portions 32p between the recess portion 32d and the outer end face in the axial direction of the support part 32, the protruding portions 32p extending in the peripheral direction of the support part 32 and protruding inward in the radial direction. This enables the flow of lubricating oil that flows out from the inner end portion 20bi of the side gear 20 and heads toward the tooth part side of the outer periphery of the side gear 20 along the outer periphery of the inner end portion 20bi to be guided also toward the recess portion 32d side due to it being appropriately narrowed by means of the protruding portion 32p, and it is possible to accordingly increase the amount of lubricating oil supplied to the recess portion 32d, thus further enhancing the effect in lubricating the rotating sliding part or the meshing part.

Moreover, the side face 32ps, on the side facing the recess portion 32d, of the protruding portion 32p is formed so as to be inclined toward the bottom face side of the recess portion 32d in going from the extremity of the protruding portion 32p toward the inside in the axial direction. Since it is thereby possible to efficiently collect in the recess portion 32p lubricating oil that has flowed out via the inner end portion 20bi of the side gear 20 so as to be scattered by virtue of centrifugal force because of the inclined side face 32ps of the protruding portion 32p functioning as a guide face, the amount of lubricating oil supplied to the recess portion 32p can accordingly be increased, thereby enabling the effect in lubricating the rotating sliding part or meshing part to be enhanced.

The side gear 20 of the present embodiment includes the side gear main body 20m having a tooth part and the boss portions 20b integrally joined to the inner peripheral part of the side gear main body 20m and fitted and linked to the corresponding drive shafts S1, S2, and the inner end portion 20bi of the boss portion 20b is present further on the inner side in the axial direction than the side gear main body 20m and protrudes into the inner space of the support part 32. In this way, due to the boss portion 20b of the side gear 20 extending to the interior of the support part 32, it is possible to ensure a large length via which the boss portion 20b is fitted onto the drive shafts S1, S2 in the axial direction (that is, the length via which they are linked) compared with the axial dimension of the side gear main body 20m, and even if the side gear main body 20m (and consequently the differential device D) is flat in the axial direction, the strength via which the side gear 20 and the drive shafts S1, S2 are linked can easily be ensured.

Furthermore, even when the boss portions 20b of the left and right side gears 20 are extended into the support part 32 as described above, since the inner end portions 20bi of the two boss portions 20b closely oppose each other while sandwiching therebetween the gap s, through which lubricating oil can flow, it is possible to supply lubricating oil to the recess portion 32d in the inner peripheral face of the support part 32 without problems while ensuring a long length via which the boss portion 20b protrudes inward in the axial direction.

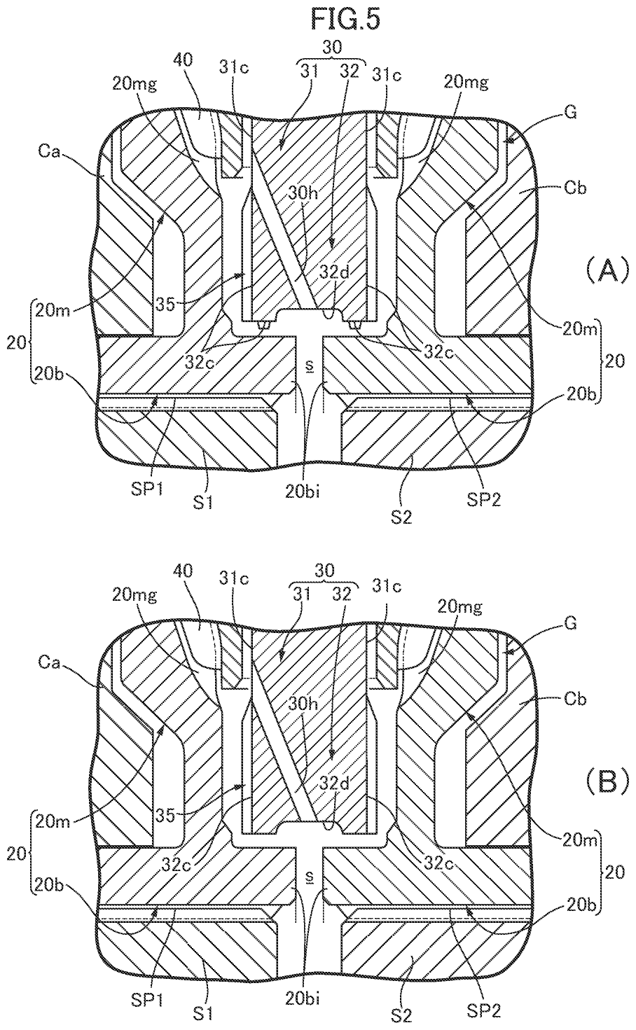

FIG. 5 shows another embodiment of the present invention. The first embodiment illustrates a case in which the recess portion 32d in the inner peripheral face of the support part 32 of the pinion shaft 30 is formed by providing the pair of protruding portions 32p on the inner peripheral face of the support part 32 so as to be parallel to each other (that is, the protruding portions 32p form the opposite walls of the recess portion 32d). On the other hand, in a second embodiment shown in FIG. 5 (A), the protruding portions 32p are formed at a position displaced further outward in the axial direction than the recess portion 32d, and this enables an area via which lubricating oil is collected by means of the two protruding portions 32p to be widened in the axial direction, thus enhancing the collection effect.

In a third embodiment shown in FIG. 5 (B), the protruding portion 32p is omitted, and the recess portion 32d is provided directly in the inner peripheral face of the support part 32 so that an intermediate part of the inner peripheral face of the support part 32 is recessed outward in the radial direction.

The structure of the second and third embodiments is otherwise the same as that of the first embodiment. The differential device D of the second and third embodiments can achieve basically the same effects as those of the first embodiment by specifically providing the recess portion 32d in the inner peripheral face of the support part 32 and disposing the inner end portion 20bi of the side gear 20 within the width in the axial direction of the recess portion 32d.

Embodiments of the present invention are explained above, but the present invention is not limited to the above embodiments and may be modified in a variety of ways as long as the modifications do not depart from the subject matter.

For example, in the embodiments the differential device D is housed within the transmission case M of the automobile, but the differential device D is not limited to a differential device for an automobile and may be implemented as a differential device for various machines and devices. Moreover, the embodiments illustrate a case in which the differential device D is applied to left and right wheel transmission systems and power is distributed between the left and right wheels while allowing differential rotation, but in the present invention the differential device may be applied to front and rear wheel transmission systems of a front and rear wheel drive vehicle, and power may be distributed between the front and rear wheels while allowing differential rotation.

The embodiments illustrate a case in which the pinion gear 40 and the side gear 20 are formed from bevel gears, but in the present invention the pinion gear 40 and the side gear 20 may be a gear other than a bevel gear and, for example, the side gear 40 may be formed from a face gear and the pinion gear 20 rotatably fitted to and supported on the shaft part 31 of the pinion shaft 30 may be formed from a spur gear or a helical gear that meshes with the side gear 40 as a face gear.

The embodiments illustrate a case in which the inner end parts of the left and right side gears 20 (more specifically the inner end portion 20bi of the boss portion 20b) protrude into the inner space of the annular support part 32 of the pinion shaft 30, and are positioned within the width of the recess portion 32d in the axial direction, but the present invention may be implemented such that only the inner end part of either one of the left and right side gears 20 (the inner end portion 20bi of the boss portion 20b) protrudes into the inner space of the annular support part 32 and is positioned within the width of the recess portion 32d in the axial direction.

The embodiments illustrate a case in which the number of shaft parts 31 of the pinion shaft 30 (and consequently the pinion gears 40) is four, but the number of shaft parts 31 is not limited to that of the embodiments and may be any as long as it is at least two (that is, a plurality). It is desirable that the plurality of shaft parts 31 are disposed at equal intervals in the peripheral direction.

The embodiments illustrate a case in which the outer periphery of the shaft part 31 of the pinion shaft 30 is in line contact with the support groove Bah of the differential case C (ring gear Cg), but a flat face may be formed on the outer peripheral face of the shaft part 31 so as to be out of phase with the cutout portion 31c, the flat face being in sliding surface contact with the support groove 8ah.

The embodiments illustrate a case in which there are provided both the through hole 30h and the lubricating oil passage 35 as oil guide parts, but the present invention may be implemented such that there is provided either one of the through hole 30h and the lubricating oil passage 35 as an oil guide part.

1. A differential device comprising:
a pair of side gears linked to a pair of rotating shafts respectively,
a plurality of pinion gears meshing with the pair of side gears, and
a pinion shaft supporting the plurality of pinion gears, wherein
the pinion shaft comprises a plurality of shaft parts rotatably fitted to and supporting the plurality of pinion gears respectively, and an annular support part linking the plurality of shaft parts to each other,
an annular recess portion is formed in an inner peripheral face of the support part,
the pinion shaft has an oil guide part that guides lubricating oil within the recess portion to a part where the shaft part and the pinion gear are fitted together, and
an inner end portion of at least one of the side gears protrudes into an inner space of the support part and is positioned within a width of the recess portion in an axial direction of the rotating shaft.

2. The differential device according to claim 1, wherein a protruding portion is provided on the inner peripheral face of the support part between the recess portion and an outer end face of the support part in the axial direction, the protruding portion extending in a peripheral direction of the support part and protruding inward in a radial direction.

3. The differential device according to claim 2, wherein a side face, on a side facing the recess portion, of the protruding portion is formed so as to be inclined toward a bottom face side of the recess portion in going inward in the axial direction from an extremity of the protruding portion.

4. The differential device according to claim 1, wherein the pair of side gears each comprise a side gear main body having a tooth portion, and a boss portion integrally joined to an inner peripheral part of the side gear main body and fitted and linked to the corresponding rotating shaft,
the inner end portion of the boss portion being present further inward than the side gear main body in the axial direction and projecting into an inner space of the support part, and
the inner end portions of the boss portions of the pair of side gears opposing each other with a gap(s) sandwiched therebetween through which lubricating oil can flow.

5. The differential device according to claim 1, wherein the pinion shaft has a through hole having one end opening on an inner face of the recess portion and having the other end opening on an outer peripheral portion of the shaft part or a portion, adjacent to the shaft part, of the support part, and the through hole forms the oil guide part.

6. The differential device according to claim 1, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

7. The differential device according to claim 2, wherein the pair of side gears each comprise a side gear main body having a tooth portion, and a boss portion integrally joined to an inner peripheral part of the side gear main body and fitted and linked to the corresponding rotating shaft,
the inner end portion of the boss portion being present further inward than the side gear main body in the axial direction and projecting into an inner space of the support part, and
the inner end portions of the boss portions of the pair of side gears opposing each other with a gap(s) sandwiched therebetween through which lubricating oil can flow.

8. The differential device according to claim 3, wherein the pair of side gears each comprise a side gear main body having a tooth portion, and a boss portion integrally joined to an inner peripheral part of the side gear main body and fitted and linked to the corresponding rotating shaft,
the inner end portion of the boss portion being present further inward than the side gear main body in the axial direction and projecting into an inner space of the support part, and
the inner end portions of the boss portions of the pair of side gears opposing each other with a gap(s) sandwiched therebetween through which lubricating oil can flow.

9. The differential device according to claim 2, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

10. The differential device according to claim 3, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

11. The differential device according to claim 4, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

12. The differential device according to claim 7, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.

13. The differential device according to claim 8, wherein part of a surface of each of the shaft part and the support part is cut out, a cutout portion thus cut out forms a lubricating oil passage extending from an interior of the recess portion to the part where the shaft part and the pinion gear are fitted together, and the lubricating oil passage forms the oil guide part.
